(19) United States
(12) Patent Application Publication
(10) Pub. No.: US 2026/0018599 A1
(43) Pub. Date: Jan. 15, 2026

(54) SECONDARY BATTERY

(71) Applicant: MURATA MANUFACTURING CO., LTD., Kyoto (JP)

(72) Inventors: Yohei SHIMADA, Kyoto (JP); Yukihiro OKAMOTO, Kyoto (JP)

(21) Appl. No.: 19/248,851

(22) Filed: Jun. 25, 2025

(30) Foreign Application Priority Data
Jul. 9, 2024 (JP) 2024-110395

(51) Int. Cl. H01M 4/36; H01M 4/02; H01M 4/38; H01M 4/583

(52) U.S. Cl. CPC H01M 4/366; H01M 4/386; H01M 4/583; H01M 2004/021; H01M 2004/027

(57) ABSTRACT

A secondary battery is provided and includes a sheet-like positive electrode and a sheet-like negative electrode laminated on the positive electrode with a separator interposed therebetween. The positive electrode and the negative electrode are wound. The negative electrode includes a sheet-like negative electrode current collector, a first negative electrode material layer disposed on an inner surface on an inner side in a lamination direction in the negative electrode current collector, and a second negative electrode material layer disposed on an outer surface on an outer side in the lamination direction in the negative electrode current collector. The first negative electrode material layer is larger than the second negative electrode material layer in terms of an expansion coefficient in a thickness direction of the negative electrode in a charged state with respect to a discharged state.

### CROSS REFERENCE TO RELATED APPLICATIONS

The present application claims priority to Japanese Patent Application No. 2024-110395, filed on Jul. 9, 2024, the entire contents of which are incorporated herein by reference.

### BACKGROUND

The present disclosure relates to a secondary battery.

An example of a secondary battery includes a nonaqueous electrolyte secondary battery including a wound electrode assembly in which sheet-like positive and negative electrodes are wound with a separator interposed therebetween. In the secondary battery, graphite and a Si-containing material are used as a negative electrode active material.

In terms of lithium storage amount per unit area, the Si-containing material is more than a carbon material such as graphite. Therefore, by using the Si-containing material for the negative electrode active material, capacity of the battery can be increased.

### SUMMARY

The present disclosure relates to a secondary battery.

However, the Si-containing material has a relatively large volume change due to charging and discharging of the secondary battery. Therefore, particularly at a portion on a winding start side in the wound electrode assembly, the electrode assembly may be deformed toward a center side of the electrode assembly and may be buckled. When buckling of the electrode assembly occurs, there is a possibility that characteristics (so-called cycle characteristics) related to deterioration of the secondary battery due to repeated charging and discharging of the secondary battery are deteriorated.

The present disclosure, in an embodiment, relates to suppressing deterioration of the cycle characteristics in the secondary battery.

A secondary battery of the present disclosure, in an embodiment, includes: a sheet-like positive electrode; and
a sheet-like negative electrode laminated on the positive electrode with a separator interposed therebetween, in which the positive electrode and the negative electrode are wound, the negative electrode includes: a sheet-like negative electrode current collector; a first negative electrode material layer disposed on an inner surface on an inner side in a lamination direction in the negative electrode current collector; and a second negative electrode material layer disposed on an outer surface on an outer side in the lamination direction in the negative electrode current collector, and the first negative electrode material layer is larger than the second negative electrode material layer in terms of an expansion coefficient in a thickness direction of the negative electrode in a charged state with respect to a discharged state.

According to the secondary battery of the present disclosure, it is possible to suppress deterioration of the cycle characteristics.

### BRIEF DESCRIPTION OF THE FIGURES

FIG. 1 is a sectional view of a secondary battery according to an embodiment of the present disclosure;

FIG. 2 is an enlarged partial sectional view of an electrode assembly taken along line II-II illustrated in FIG. 1;

FIG. 3 is a partly enlarged sectional view illustrating a bending degree when the electrode assembly of the secondary battery of Example 1 is charged;

FIG. 4 is a partly enlarged sectional view illustrating the bending degree when the electrode assembly of the secondary battery of Comparative Example 1 is charged; and

FIG. 5 is a partly enlarged sectional view illustrating the bending degree when the electrode assembly of the secondary battery of Comparative Example 2 is charged.

### DETAILED DESCRIPTION

The present application will be described below in further detail including with reference to the drawings according to an embodiment. Note that the present disclosure is not limited thereto. Each of the embodiments is an example, and it goes without saying that configurations shown in the different embodiments can be partly replaced or combined with each other.

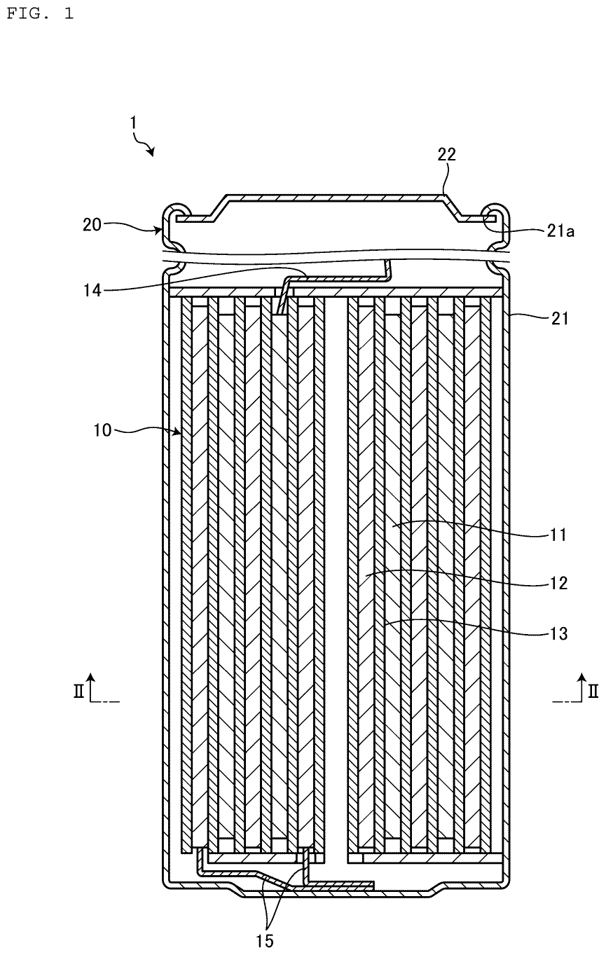

FIG. 1 is a sectional view of a secondary battery 1 according to an embodiment of the present disclosure.

The secondary battery 1 is, for example, a lithium battery. The secondary battery 1 includes an electrode assembly 10 and a housing 20.

The electrode assembly 10 is a wound electrode assembly. In the electrode assembly 10, a sheet-like positive electrode 11 and a sheet-like negative electrode 12 are laminated and wound with a separator 13 interposed therebetween. The electrode assembly 10 has a cylindrical shape. The electrode assembly 10 may have a flattened shape. Details of the positive electrode 11 and the negative electrode 12 will be described later.

The electrode assembly 10 includes a strip-shaped positive electrode terminal 14 electrically connected to the positive electrode 11 and a strip-shaped negative electrode terminal 15 electrically connected to the negative electrode 12.

The housing 20 includes a main body 21 and a lid 22. Materials of the main body 21 and the lid 22 have conductivity. The materials of the main body 21 and the lid 22 are, for example, iron, stainless steel, or aluminum.

The main body 21 has a tubular shape having an opening 21a on one end side. The negative electrode terminal 15 is electrically connected to an inner surface of the main body 21.

The lid 22 covers the opening 21a of the main body 21. The lid 22 is disposed on the main body 21 in a state of being electrically insulated from the main body 21. The positive electrode terminal 14 is electrically connected to the lid 22.

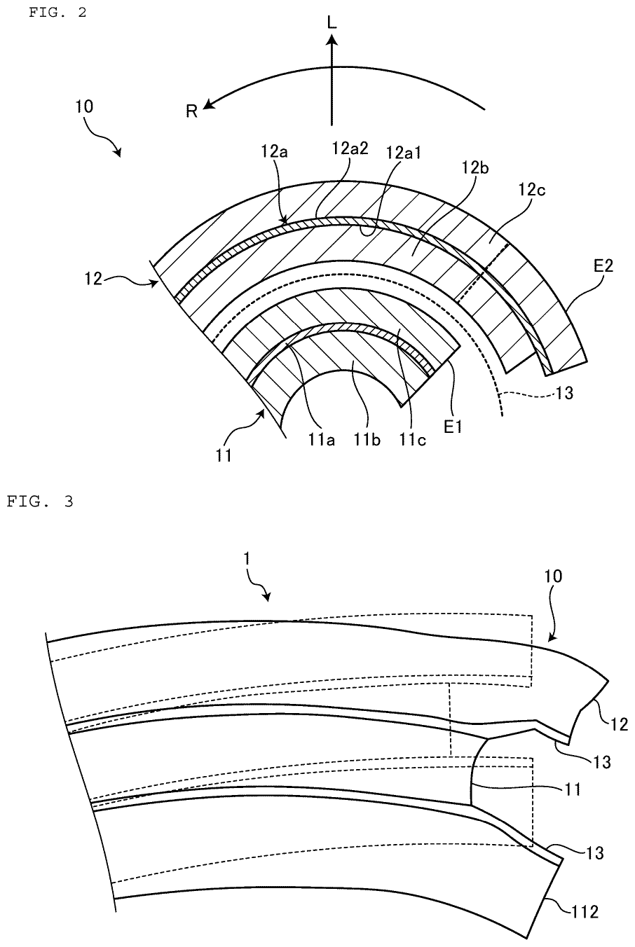

FIG. 2 is an enlarged partial sectional view of the electrode assembly 10 taken along line II-II illustrated in FIG. 1. The electrode assembly 10 illustrated in FIG. 2 is in a discharged state. In FIG. 2, the separator 13 is indicated by a broken line. In FIG. 2, arrows indicating a winding direction R and a lamination direction L are illustrated.

A side indicated by the arrow in the winding direction R is a winding end side of the electrode assembly 10, and an opposite side thereof is a winding start side of the electrode assembly 10. In the electrode assembly 10, a winding start end is positioned on an inner side, and a winding end is positioned on an outer side.

The lamination direction L is a direction in which the positive electrode 11, the negative electrode 12, and the separator 13 are laminated, and is orthogonal to the winding direction R. In the lamination direction L, a side indicated by the arrow is a side outward of the electrode assembly 10, and an opposite side thereof is a direction inward of the electrode assembly 10.

FIG. 2 illustrates a part of the electrode assembly 10 including an end on the winding start side.

The positive electrode 11 has a sheet shape. The positive electrode 11 includes a positive electrode current collector 11a, a first positive electrode material layer 11b, and a second positive electrode material layer 11c. The positive electrode current collector 11a, the first positive electrode material layer 11b, and the second positive electrode material layer 11c each have a sheet shape.

The positive electrode current collector 11a is a conductor layer, and is, for example, a metal. Specifically, a material of the positive electrode current collector 11a is aluminum or the like.

The first positive electrode material layer 11b and the second positive electrode material layer 11c are arranged on opposite sides to each other with the positive electrode current collector 11a interposed therebetween. The first positive electrode material layer 11b is located inside the second positive electrode material layer 11c in the lamination direction L. The first positive electrode material layer 11b and the second positive electrode material layer 11c contain a positive electrode active material. The positive electrode active material is, for example, a metal oxide containing a lithium ion, specifically, lithium cobalt oxide, lithium nickel oxide, or the like.

The negative electrode 12 has a sheet shape. The negative electrode 12 includes a negative electrode current collector 12a, a first negative electrode material layer 12b, and a second negative electrode material layer 12c. The negative electrode current collector 12a, the first negative electrode material layer 12b, and the second negative electrode material layer 12c each have a sheet shape.

The negative electrode current collector 12a is a conductor layer, and is, for example, a metal. Specifically, a material of the negative electrode current collector 12a is copper.

The first negative electrode material layer 12b and the second negative electrode material layer 12c are arranged on opposite sides to each other with the negative electrode current collector 12a interposed therebetween. The first negative electrode material layer 12b is located inside the second negative electrode material layer 12c in the lamination direction L. Specifically, the first negative electrode material layer 12b is disposed on an inner surface 12a1 on the inner side in the lamination direction L in the negative electrode current collector 12a. The second negative electrode material layer 12c is disposed on an outer surface 12a2 on the outer side in the lamination direction L in the negative electrode current collector 12a.

The first negative electrode material layer 12b and the second negative electrode material layer 12c contain a negative electrode active material. The negative electrode active material contains both graphite and a silicon-containing material. Specifically, the silicon-containing material is a silicon oxide represented by a general formula: SiOx (x in the formula is a real number satisfying 0≤x≤2). The silicon-containing material may be a material containing at least one of the silicon oxide, a mixture of silicon and a carbon material, a mixture of a silicon compound and the carbon material, and silicon.

Further, the first negative electrode material layer 12b is larger than the second negative electrode material layer 12c in terms of a ratio of a first weight of the silicon-containing material to a total weight of the first weight of the silicon-containing material and a second weight of the graphite (=first weight×100/(first weight+second weight): hereinafter, referred to as “silicon ratio”). Thus, the first negative electrode material layer 12b is larger than the second negative electrode material layer 12c in terms of an expansion coefficient in a thickness direction of the negative electrode 12 in a state where the electrode assembly 10 is charged with respect to a state where the electrode assembly 10 is discharged.

That is, when the electrode assembly 10 is changed from a discharged state to a charged state, an expansion coefficient of the first negative electrode material layer 12b in the thickness direction is larger than the expansion coefficient of the second negative electrode material layer 12c in the thickness direction. Therefore, when the electrode assembly 10 is brought into the charged state from the discharged state, the negative electrode 12 is suppressed from being bent inward in the lamination direction L, and the negative electrode 12 is suppressed from being buckled.

In FIG. 2, the winding start end of the positive electrode 11 is closer to the winding end side of the negative electrode 12 in the winding direction R than the winding start end of the negative electrode 12. In other words, the first negative electrode material layer 12b is laminated on the outer side in the lamination direction L of the end (hereinafter, referred to as an “inner end E1 of the positive electrode 11”) on the winding start side in the positive electrode 11 with the separator 13 interposed therebetween. As described above, the negative electrode 12 is suppressed from being bent inward in the lamination direction L. Therefore, when the negative electrode 12 is bent toward the inner end E1 of the positive electrode 11, the separator 13 is pressed by the inner end E1 of the positive electrode 11 and the negative electrode 12, and the separator 13 is suppressed from being broken by the inner end E1 of the positive electrode 11. Therefore, a short circuit between the positive electrode 11 and the negative electrode 12 is suppressed.

An end (hereinafter, referred to as an “inner end E2 of the negative electrode 12”) on the winding start side in the negative electrode 12 overlaps the outer side in the lamination direction L of the inner end E1 of the positive electrode 11 with the separator 13 interposed therebetween. Since the inner end E2 of the negative electrode 12 has a space at a center of the electrode assembly 10, the inner end E2 is easily bent inward in the lamination direction L as compared with other portions of the negative electrode 12. On the other hand, as described above, the negative electrode 12 is suppressed from being bent inward in the lamination direction L. Therefore, also when the inner end E2 of the negative electrode 12 overlaps the inner end E1 of the positive electrode 11 in the lamination direction L, the separator 13 is suppressed from being broken by the inner end E1 of the positive electrode 11, and the short circuit between the positive electrode 11 and the negative electrode 12 is suppressed.

The negative electrode 12 may be laminated on the inner side in the lamination direction L of the positive electrode 11. The negative electrode 12 may be laminated on both sides in the lamination direction L of the positive electrode 11.

Next, results when the secondary battery 1 of the above embodiment and secondary batteries of Comparative Examples are repeatedly charged and discharged are compared. Note that in this comparison, the silicon-containing material is silicon oxide.

In the following Table 1, a column of “active material composition ratio” indicates a weight ratio of silicon oxide and a weight ratio of graphite in columns of “weight ratio of silicon oxide” and “weight ratio of graphite” for each of the first negative electrode material layer 12b and the second negative electrode material layer 12c. Further, a column of “silicon ratio” indicates the silicon ratio (=first weight×100/(first weight+second weight)) for each of the first negative electrode material layer 12b and the second negative electrode material layer 12c.

Further, a column of “inner/outer silicon abundance ratio” indicates a ratio of the silicon ratio of the first negative electrode material layer 12b to the silicon ratio of the second negative electrode material layer 12c (=silicon ratio of the first negative electrode material layer 12b/silicon ratio of the second negative electrode material layer 12c).

Furthermore, a column of “thickness before charge” indicates a thickness of each of the first negative electrode material layer 12b and the second negative electrode material layer 12c before the electrode assembly 10 is charged (in a discharged state). A column of “expansion coefficient” indicates a ratio of an increase amount of a thickness after charge to a thickness before charge (=increase amount of the thickness after charge×100/thickness before charge) for each of the first negative electrode material layer 12b and the second negative electrode material layer 12c. A column of “inner/outer expansion ratio” indicates a ratio of the expansion coefficient of the first negative electrode material layer 12b to the expansion coefficient of the second negative electrode material layer 12c (=expansion coefficient of the first negative electrode material layer 12b/expansion coefficient of the second negative electrode material layer 12c).

Further, a column of “presence or absence of short circuit in cycle test” indicates presence or absence of the short circuit between the positive electrode 11 and the negative electrode 12 in a cycle test which is a test for repeating charging and discharging of the electrode assembly 10.

TABLE 1

| | | | Example | Example | Example | Comparative | Comparative |
|---|---|---|---|---|---|---|---|
| | | | 1 | 2 | 3 | Example 1 | Example 2 |
| Active | First | Weight ratio of | 18.0 | 16.0 | 15.5 | 15.0 | 12.0 |
| material | negative | silicon oxide (%) | | | | | |
| composition | electrode | Weight ratio of | 82.0 | 84.0 | 84.5 | 85.0 | 88.0 |
| ratio | material | graphite (%) | | | | | |
| | layer | Silicon ratio (%) | 18.0 | 16.0 | 15.5 | 15.0 | 12.0 |
| | Second | Weight ratio of | 12.0 | 14.0 | 14.5 | 15.0 | 18.0 |
| | negative | silicon oxide (%) | | | | | |
| | electrode | Weight ratio of | 88.0 | 86.0 | 85.5 | 85.0 | 82.0 |
| | material | graphite (%) | | | | | |
| | layer | Silicon ratio (%) | 12.0 | 14.0 | 14.5 | 15.0 | 18.0 |

| Inner/outer silicon abundance ratio | | 1.50 | 1.14 | 1.07 | 1.00 | 0.67 |
|---|---|---|---|---|---|---|
| First negative | Thickness before | 33.3 | 34.0 | 34.7 | 35.0 | 36.3 |
| electrode | charge (μm) | | | | | |
| material layer | Expansion | 41.0 | 36.3 | 35.6 | 35.2 | 32.1 |
| | coefficient (%) | | | | | |
| Second negative | Thickness before | 36.3 | 35.7 | 35.3 | 34.7 | 33.3 |
| electrode | charge (μm) | | | | | |
| material layer | Expansion | 32.1 | 34.6 | 34.9 | 35.6 | 39.0 |
| | coefficient (%) | | | | | |

| | | | | | |
|---|---|---|---|---|---|
| Inner/outer expansion ratio | 1.28 | 1.05 | 1.02 | 0.99 | 0.82 |
| Presence or absence of short | No | No | No | Yes | Yes |
| circuit in cycle test | | | | (310 times) | (290 times) |

The secondary battery 1 of each of Examples 1, 2, and 3 is the secondary battery 1 of the above embodiment, and the silicon ratio of the first negative electrode material layer 12b is larger than the silicon ratio of the second negative electrode material layer 12c. Therefore, in secondary batteries of Examples 1, 2, and 3, the “inner/outer silicon abundance ratio” is larger than 1.

Specifically, in the secondary battery 1 of Example 1, the weight ratio of silicon oxide in the first negative electrode material layer 12b is “18.0 (%)”, the weight ratio of graphite is “82.0 (%)”, and the silicon ratio is “18.0 (%)”. Further, the weight ratio of silicon oxide in the second negative electrode material layer 12c is “12.0 (%)”, the weight ratio of graphite is “88.0 (%)”, and the silicon ratio is “12.0 (%)”. Furthermore, the inner/outer silicon abundance ratio is “1.50”.

Further, the thickness of the first negative electrode material layer 12b before charge is “33.3 (μm)”, and the expansion coefficient thereof is “41.0 (%)”. The thickness of the second negative electrode material layer 12c before charge is “36.3 (μm)”, and the expansion coefficient thereof is “32.1 (%)”. Furthermore, the inner/outer expansion ratio is “1.28”.

Further, in the secondary battery 1 of Example 2, the weight ratio of silicon oxide in the first negative electrode material layer 12b is “16.0 (%)”, the weight ratio of graphite is “84.0 (%)”, and the silicon ratio is “16.0 (%)”. Further, the weight ratio of silicon oxide in the second negative electrode material layer 12c is “14.0 (%)”, the weight ratio of graphite is “86.0 (%)”, and the silicon ratio is “14.0 (%)”. Furthermore, the inner/outer silicon abundance ratio is “1.14”.

Further, the thickness of the first negative electrode material layer 12b before charge is “34.0 (μm)”, and the expansion coefficient thereof is “36.3 (%)”. The thickness of the second negative electrode material layer 12c before charge is “35.7 (μm)”, and the expansion coefficient thereof is “34.6 (%)”. Furthermore, the inner/outer expansion ratio is “1.05”.

Further, in the secondary battery 1 of Example 3, the weight ratio of silicon oxide in the first negative electrode material layer 12b is “15.5 (%)”, the weight ratio of graphite is “84.5 (%)”, and the silicon ratio is “15.5 (%)”. Further, the weight ratio of silicon oxide in the second negative electrode material layer 12c is “14.5 (%)”, the weight ratio of graphite is “85.5 (%)”, and the silicon ratio is “14.5 (%)”. Furthermore, the inner/outer silicon abundance ratio is “1.07”.

Further, the thickness of the first negative electrode material layer 12b before charge is “34.7 (μm)”, and the expansion coefficient thereof is “35.6 (%)”. The thickness of the second negative electrode material layer 12c before charge is “35.3 (μm)”, and the expansion coefficient thereof is “34.9 (%)”. Furthermore, the inner/outer expansion ratio is “1.02”.

In the secondary batteries 1 of Examples 1, 2, and 3, there was no short circuit between the positive electrode 11 and the negative electrode 12 until the number of repetitions of charging and discharging reached a predetermined number of times (for example, 2000 times).

The secondary battery of Comparative Example 1 is different from the secondary battery 1 of the above embodiment only in that the silicon ratio of the first negative electrode material layer 12b is equal to the silicon ratio of the second negative electrode material layer 12c.

Specifically, in the secondary battery of Comparative Example 1, the weight ratio of silicon oxide in the first negative electrode material layer 12b is “15.0 (%)”, the weight ratio of graphite is “85.0 (%)”, and the silicon ratio is “15.0 (%)”. Further, the weight ratio of silicon oxide in the second negative electrode material layer 12c is “15.0 (%)”, the weight ratio of graphite is “85.0 (%)”, and the silicon ratio is “15.0 (%)”. Furthermore, the inner/outer silicon abundance ratio is “1.00”.

Further, the thickness of the first negative electrode material layer 12b before charge is “35.0 (μm)”, and the expansion coefficient thereof is “35.2 (%)”. The thickness of the second negative electrode material layer 12c before charge is “34.7 (μm)”, and the expansion coefficient thereof is “35.6 (%)”. Furthermore, the inner/outer expansion ratio is “0.99”.

In the secondary battery of Comparative Example 1, the short circuit occurred between the positive electrode 11 and the negative electrode 12 when the number of repetitions of charging and discharging was 310 times which was less than the predetermined number.

The secondary battery of Comparative Example 2 is different from the secondary battery 1 of the above embodiment in that the silicon ratio of the second negative electrode material layer 12c is larger than the silicon ratio of the first negative electrode material layer 12b.

Specifically, in the secondary battery of Comparative Example 2, the weight ratio of silicon oxide in the first negative electrode material layer 12b is “12.0 (%)”, the weight ratio of graphite is “88.0 (%)”, and the silicon ratio is “12.0 (%)”. Further, the weight ratio of silicon oxide in the second negative electrode material layer 12c is “18.0 (%)”, the weight ratio of graphite is “82.0 (%)”, and the silicon ratio is “18.0 (%)”. Furthermore, the inner/outer silicon abundance ratio is “0.67”.

Further, the thickness of the first negative electrode material layer 12b before charge is “36.3 (μm)”, and the expansion coefficient thereof is “32.1 (%)”. The thickness of the second negative electrode material layer 12c before charge is “33.3 (μm)”, and the expansion coefficient thereof is “39.0 (%)”. Furthermore, the inner/outer expansion ratio is “0.82”.

In the secondary battery of Comparative Example 2, the short circuit occurred between the positive electrode 11 and the negative electrode 12 when the number of repetitions of charging and discharging was 290 times which was less than the predetermined number.

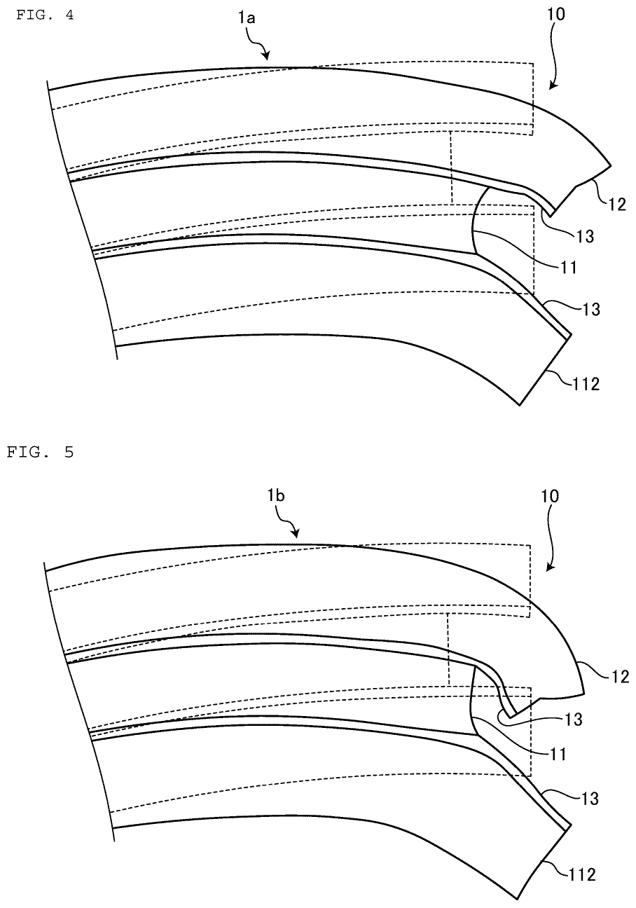

FIG. 3 is a partly enlarged sectional view illustrating a bending degree when the electrode assembly 10 of the secondary battery 1 of Example 1 is charged. FIG. 4 is a partly enlarged sectional view illustrating the bending degree when the electrode assembly 10 of a secondary battery 1a of Comparative Example 1 is charged. FIG. 5 is a partly enlarged sectional view illustrating the bending degree when the electrode assembly 10 of a secondary battery 1b of Comparative Example 2 is charged.

FIGS. 3, 4, and 5 illustrate a sectional shape of a portion on a winding start side in the electrode assembly 10 similarly to FIG. 2. In the electrode assembly 10 illustrated in FIGS. 3, 4, and 5, a negative electrode 112 is further laminated on the inner side of the positive electrode 11 in the lamination direction L. The content shown in Table 1 relates to the negative electrode 12 laminated on the outer side of the positive electrode 11 in the lamination direction L. The negative electrode 112 is configured similarly to the negative electrode 12. Further, in FIGS. 3, 4, and 5, the shape of the electrode assembly 10 before charge is indicated by a broken line, and the shape of the electrode assembly 10 after charge is illustrated by a solid line.

As illustrated in FIGS. 3, 4, and 5, a bending degree of the negative electrode 12 after charge increases in an order of Example 1, Comparative Example 1, and Comparative Example 2. That is, in the order of Example 1, Comparative Example 1, and Comparative Example 2, a force with which the inner end E1 of the positive electrode 11 presses the separator 13 increases, and the short circuit between the positive electrode 11 and the negative electrode 12 is likely to occur. Therefore, in Table 1, there is no short circuit between the positive electrode 11 and the negative electrode 12 in Example 1, the short circuit between the positive electrode 11 and the negative electrode 12 occurs in Comparative Examples 1 and 2, and the short circuit occurs earlier in Comparative Example 2 than in Comparative Example 1.

The fact that the bending degree of the negative electrode 12 after charge increases in the order of Example 1, Comparative Example 1, and Comparative Example 2 corresponds to the fact that the inner/outer silicon abundance ratio shown in Table 1 decreases in the order of Example 1, Comparative Example 1, and Comparative Example 2. That is, in Example 1, since the silicon ratio of the first negative electrode material layer 12b is larger than the silicon ratio of the second negative electrode material layer 12c, bending of the negative electrode 12 after charge is suppressed, and the short circuit between the positive electrode 11 and the negative electrode 12 is suppressed. Therefore, the secondary battery 1 of the above embodiment can suppress deterioration of cycle characteristics.

Note that the above embodiment is for facilitating understanding of the present disclosure, and are not intended to limit and interpret the present disclosure. The present disclosure may be modified or improved without departing from the spirit thereof, and the present disclosure includes equivalents thereof.

For example, a material of the first negative electrode material layer 12b may be graphite, and a material of the second negative electrode material layer 12c may be lithium titanate. Also in this case, the expansion coefficient of the first negative electrode material layer 12b is larger than the expansion coefficient of the second negative electrode material layer 12c. In addition, the material of the first negative electrode material layer 12b may contain graphite and a silicon-containing material, and the material of the second negative electrode material layer 12c may be graphite. Also in this case, the expansion coefficient of the first negative electrode material layer 12b is larger than the expansion coefficient of the second negative electrode material layer 12c, and the silicon ratio of the first negative electrode material layer 12b is larger than the silicon ratio of the second negative electrode material layer 12c.

At least at the inner end E2 of the negative electrode 12, the expansion coefficient of the first negative electrode material layer 12b may be larger than the expansion coefficient of the second negative electrode material layer 12c.

Note that the present disclosure may be a combination of the following configurations according to an embodiment.

(1)

A secondary battery including:
a sheet-like positive electrode; and
a sheet-like negative electrode laminated on the positive electrode with a separator interposed therebetween, in which
the positive electrode and the negative electrode are wound,
the negative electrode includes:
a sheet-like negative electrode current collector;
a first negative electrode material layer disposed on an inner surface on an inner side in a lamination direction in the negative electrode current collector; and
a second negative electrode material layer disposed on an outer surface on an outer side in the lamination direction in the negative electrode current collector, and
the first negative electrode material layer is larger than the second negative electrode material layer in terms of an expansion coefficient in a thickness direction of the negative electrode in a charged state with respect to a discharged state.
   (2)

The secondary battery according to (1), in which
the first negative electrode material layer and the second negative electrode material layer each contain graphite and a silicon-containing material, and
the first negative electrode material layer is larger than the second negative electrode material layer in terms of a ratio of a first weight of the silicon-containing material to a total weight of the first weight of the silicon-containing material and a second weight of the graphite.
   (3)

The secondary battery according to (2), in which the silicon-containing material is a silicon oxide represented by a general formula: SiOx (x in the formula is a real number satisfying 0≤x≤2).

(4)

The secondary battery according to any one of (1) to (3), in which the first negative electrode material layer is laminated on an outer side in a lamination direction of an inner end of the positive electrode with the separator interposed therebetween.

(5)

The secondary battery according to (4), in which
an inner end of the negative electrode overlaps the outer side in the lamination direction of the inner end of the positive electrode with the separator interposed therebetween, and
the expansion coefficient of the first negative electrode material layer is larger than the expansion coefficient of the second negative electrode material layer at least at the inner end of the negative electrode in the negative electrode.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a sheet-like positive electrode; and
a sheet-like negative electrode laminated on the positive electrode with a separator interposed therebetween,
wherein the positive electrode and the negative electrode are wound,
the negative electrode includes:
a sheet-like negative electrode current collector;
a first negative electrode material layer disposed on an inner surface on an inner side in a lamination direction in the negative electrode current collector; and
a second negative electrode material layer disposed on an outer surface on an outer side in the lamination direction in the negative electrode current collector, and
the first negative electrode material layer is larger than the second negative electrode material layer in terms of an expansion coefficient in a thickness direction of the negative electrode in a charged state with respect to a discharged state.

2. The secondary battery according to claim 1, wherein
the first negative electrode material layer and the second negative electrode material layer each contain graphite and a silicon-containing material, and
the first negative electrode material layer is larger than the second negative electrode material layer in terms of a ratio of a first weight of the silicon-containing material to a total weight of the first weight of the silicon-containing material and a second weight of the graphite.

3. The secondary battery according to claim 2, wherein the silicon-containing material is a silicon oxide represented by a general formula: SiOx (x in the formula is a real number satisfying 0≤x≤2).

4. The secondary battery according to claim 1, wherein the first negative electrode material layer is laminated on an outer side in a lamination direction of an inner end of the positive electrode with the separator interposed therebetween.

5. The secondary battery according to claim 4, wherein
an inner end of the negative electrode overlaps the outer side in the lamination direction of the inner end of the positive electrode with the separator interposed therebetween, and
the expansion coefficient of the first negative electrode material layer is larger than the expansion coefficient of the second negative electrode material layer at least at the inner end of the negative electrode in the negative electrode.
